(19) United States
(12) Patent Application Publication
(10) Pub. No.: US 2015/0074589 A1
(43) Pub. Date: Mar. 12, 2015

(54) Smart Mobile Device Having Dual-Window Displaying Function

(71) Applicant: Shanghai PowerMo Information Tech. Co. Ltd., Shanghai (CN)

(72) Inventors: Qi Pan, Shanghai (CN); Xing Lee, Shanghai (CN); Jian-Jing Shen, Shanghai (CN); Xiong-Hui Guo, Shanghai (CN)

(73) Assignee: Shanghai PowerMo Information Tech. Co. Ltd., Shanghai (CN)

(21) Appl. No.: 14/141,570

(22) Filed: Dec. 27, 2013

(30) Foreign Application Priority Data
Sep. 11, 2013 (CN) 201310414212.X

(51) Int. Cl. G06F 3/0481

(52) U.S. Cl. CPC G06F 3/0481
USPC 715/781

(57) ABSTRACT

The present invention provides a smart mobile device having a dual-window displaying function. This smart mobile device comprises a first displaying region, a second displaying region, a separation bar, at least one status bar and at least one operation bar. The first displaying region is configured to display a first application software, the first application software is shown in a first window; the second displaying region is configured to display a second application software, the second application software is shown in a second window; the status bar is configured to optionally display a system status of the first application software or the second application software and the status bar is disposed at a periphery of the first window or the second window; the operation bar is configured to control the first application software and the second application software and the operation bar is optionally hidden or displayed at the periphery of the first window or the second window; the separation bar is disposed between the first displaying region and the second displaying region in a mobile way, wherein the first displaying region and the second displaying region are arranged in a top-bottom layout or a left-right layout. The present invention discusses various kinds of displaying mode so application softwares may be disposed in two displaying regions in a better way and these two displaying regions may be arranged on the screen in a more efficient way. The present invention also discusses interactions between application softwares in a dual window mode.

### FIELD OF THE INVENTION

The present invention relates to a method for controlling a smart mobile device, especially a smart mobile device having a dual-window displaying function and a controlling method for controlling said dual-window displaying function of such a smart mobile device.

### BACKGROUND OF THE INVENTION

Mobile devices are becoming more and more powerful. Users may use smart mobile devices to do different tasks such as works and entertainments. Early smart mobile devices have smaller displaying screens, so what may be displayed on the screens, the text content that may be displayed on the screens, the size of figures that may be displayed on the screens and the web pages that may be displayed on the screens are very limited. That is, the early smart mobile devices are designed to operate only one application software one time. If a user would like to operate or control two application softwares, he or she has to exit the ongoing application software then launch another application software. This kind of operating method is very inconvenient to users. Nowadays, there are more and more smart mobile devices with bigger screens.

Therefore, persons of ordinary skills in the art still try to develop a method enabling a user to control two application softwares on a screen of a smart mobile device and even enabling these two application softwares to transfer files and data created therefrom and communicate with each other.

### SUMMARY OF THE INVENTION

The goal of the present invention is to provide a smart mobile device having a dual-window displaying function for a user to operate and control two application softwares on a display screen of the smart mobile device and for these two application softwares to transfer files and data created therefrom and communicate with each other.

According to said purpose and other purposes, the present invention provides a smart mobile device having a dual-window displaying function. This smart mobile device comprises a first displaying region, a second displaying region, a separation bar, at least one status bar and at least one operation bar. The first displaying region is configured to display a first application software, the first application software is shown in a first window; the second displaying region is configured to display a second application software, the second application software is shown in a second window; the status bar is configured to optionally display a system status of the first application software or the second application software and the status bar is disposed at a periphery of the first window or the second window; the operation bar is configured to control the first application software or the second application software and the operation bar is optionally hidden or displayed at the periphery of the first window or the second window; the separation bar is disposed between the first displaying region and the second displaying region in a mobile way, wherein the first displaying region and the second displaying region are arranged in a top-bottom layout or a left-right layout.

The smart mobile device having a dual-window displaying function according to one embodiment of the present invention, wherein the operation bar is disposed above the first window or the second window and the smart mobile device further comprises a first operation bar and a second operation bar, the first operation bar is disposed above the first window while the second operation bar is disposed above the second window.

The smart mobile device having a dual-window displaying function according to one embodiment of the present invention, wherein the operation bar is disposed below the first window or the second window and the smart mobile device further comprises a first operation bar and a second operation bar, the first operation bar is disposed below the first window while the second operation bar is disposed below the second window.

The smart mobile device having a dual-window displaying function according to one embodiment of the present invention, wherein viewing directions of the first window and the second window have an included angle of 90 or 180 degree therebetween.

The smart mobile device having a dual-window displaying function according to one embodiment of the present invention, wherein the first window fills up the first displaying region along a horizontal direction or along a vertical direction or along both horizontal and vertical directions.

The smart mobile device having a dual-window displaying function according to one embodiment of the present invention, wherein the second window fills up the second displaying region along a horizontal direction or along a vertical direction or along both horizontal and vertical directions.

According to said purpose and other purposes, the present invention provides a method for controlling a smart mobile device having a dual-window displaying function. This method is configured to split the smart mobile device into a first displaying region and a second displaying region and to control a first application software and a second application software in order to achieve the dual-window displaying function. This method comprises the following steps: a) launching the first application software; b) displaying a software selecting panel; c) launching the second application software; d) deciding displaying modes of the first application software and the second application software; e) displaying images of the first application software and the second application software on the first displaying region and the second displaying region respectively.

The method for controlling a smart mobile device having a dual-window displaying function according to one embodiment of the present invention, wherein the software selecting of step b) may be achieved through a pull-down status bar, a pop-up dialogue box, a program initiating panel or a history panel of previously opened application softwares.

The method for controlling a smart mobile device having a dual-window displaying function according to one embodiment of the present invention, wherein the step d) of deciding displaying modes of the first application software and the second application software further comprises the following steps: d1) deciding layouts for the first region and the second region to be disposed on the smart mobile device and confirming the position of the separation bar; d2) calculating or confirming the displaying mode for the first application software; d3) calculating or confirming the displaying mode for the second application software, wherein the displaying modes for the first application software and the second application software comprise zoom-in or zoom-out along a horizontal or vertical direction. With the mobile device having a dual-window displaying function according to the present invention, a user can operate two application softwares on a screen of the device at the same time and these two application softwares can transfer files and data created therefrom and communicate with each other. The method for controlling a smart mobile device having a dual-window displaying function according to the present invention allows a user to control and switch displayed images showing these two application softwares fluently and conveniently either by default setting or manually.

Other purposes, characteristics and advantages will become apparent from the following detailed description, taken in conjunction with the accompanying drawings.

### BRIEF DESCRIPTION OF THE DRAWINGS

FIG. 1 is a schematic diagram of a smart mobile device having a dual-window displaying function according to the first embodiment of the present invention.

FIG. 2 is a schematic diagram of a smart mobile device having a dual-window displaying function according to the second embodiment of the present invention.

FIG. 3 is a schematic diagram of a smart mobile device having a dual-window displaying function according to the third embodiment of the present invention.

FIG. 4 is a schematic diagram of a smart mobile device having a dual-window displaying function according to the fourth embodiment of the present invention.

FIG. 5 is a schematic diagram of a smart mobile device having a dual-window displaying function according to the fifth embodiment of the present invention.

FIGS. 6 and 6A are schematic diagrams of a smart mobile device having a dual-window displaying function according to the sixth embodiment of the present invention.

FIG. 7 is a schematic diagram of a smart mobile device having a dual-window displaying function according to the seventh embodiment of the present invention.

FIG. 8 is a schematic diagram of a smart mobile device having a dual-window displaying function according to the eighth embodiment of the present invention.

FIG. 9 is a schematic diagram of a smart mobile device having a dual-window displaying function according to the ninth embodiment of the present invention.

FIG. 10 is a schematic diagram of a smart mobile device having a dual-window displaying function according to the tenth embodiment of the present invention.

FIG. 11 is a flow chart showing a method for controlling a smart mobile device having a dual-window displaying function according to one embodiment of the present invention.

FIGS. 12A-12D show different types of software selecting panels.

FIG. 13 is a flow chart showing a determining step of the “dual window mode”.

FIG. 14 is a flow chart showing a displaying step of the “dual window mode”.

FIGS. 15A and 15B are schematic figures showing how to control the smart mobile device using a functional key.

FIGS. 16A-16D are schematic figures showing how a window and a displaying region are coupled in the smart mobile device.

FIG. 17 is a schematic figure showing how to adjust the zoom-in or zoom-out ratio of a window and a displaying region in the smart mobile device.

FIGS. 18-21 are schematic figures showing the optimal adjustment of a displaying region of the dual window.

FIGS. 22-23 are flow charts showing how to enter and exit the dual window mode.

### DETAILED DESCRIPTION OF PREFERRED EMBODIMENTS

Some terms are used in the spec and claims of the present application to represent some specific elements. A person skilled in the art should know that hardware manufacturing companies may use different terms to call the same elements. In the spec and claims of the present application, the differences in terms are not used to distinguish different elements and the differences in functions are used to distinguish different elements. In the spec and claims, the terms “comprise/comprising/having” are open transitional phrases and they shall be construed as “comprising but not limited to.”

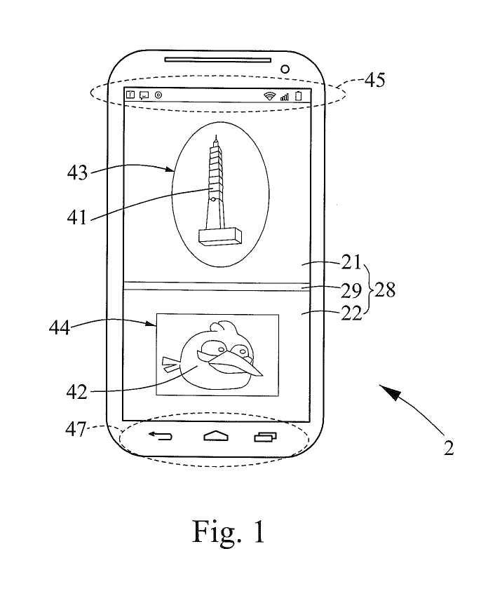

Please refer to FIG. 1 which shows a smart mobile device having a dual-window displaying function according to the first embodiment of the present invention. As shown in FIG. 1, a smart mobile device 2 comprises a first displaying region 21, a second displaying region 22, a status bar 45, an operation bar 47 and a separation bar 29. The smart mobile device 2 is disposed to stand on its narrower side(in the following will be referred to as “portrait mode”) and has its screen split into an upper portion and a bottom portion. The upper portion is the first displaying region 21 and the lower portion is the second displaying region 22. As the embodiment shown in FIG. 1, the area of the first displaying region 21 is bigger than the area of the second displaying region 22. In a preferred embodiment, the position of the separation bar 29 may be adjusted up or down through the operating system of the smart mobile device (currently the most commonly used one is Android or iOS system) or an application software so the areas of the first displaying region 21 and the second displaying region 22 may be changed according to user's need. That is, the separation bar 29 is disposed between the first displaying region 21 and the second displaying region 22 in a mobile way. Therefore, it is convenient for users to adjust the area sizes of the first displaying region 21 and the second displaying region 22 according to their own needs or using conditions.

The first displaying region 21 is configured to display a first application software 41 and the first application software 41 is shown in a first window 43. The second displaying region 22 is configured to display a second application software 42 and the second application software 42 comprises a second window 44. The status bar 45 is disposed above the first window 43 and is configured to optionally display a system status of the first application software 41 or the second application software 42. The operation bar 47 is disposed below the second window 44 and is configured to control the first application software 41 or the second application software 42. In some embodiments, the operation bar 47 may comprise hardware bottoms. In other embodiments, because the operation bar 47 is not used during the operation of the first application software 41 or the second application software 42, the operation bar 47 may be hidden in order to save the limited area of the screen 28. When a user needs to push the operation bar 47 to manipulate the first application software 41 or the second application software 42, the user may have the operation bar 47 shown through other keys (not shown) or pushing a specific site on the screen 28. Moreover, the first window 43 of this embodiment may be oval-shaped and the second window 44 may be rectangle-shaped. The width of the rectangle (along horizontal direction) is greater than the height of the rectangle (along vertical direction). The second window 44 may not fill up the whole area of the second displaying region 22. That is, the first window 43 may not couple with the first displaying region 21 and the second window 44 may not couple with the second displaying region 22.

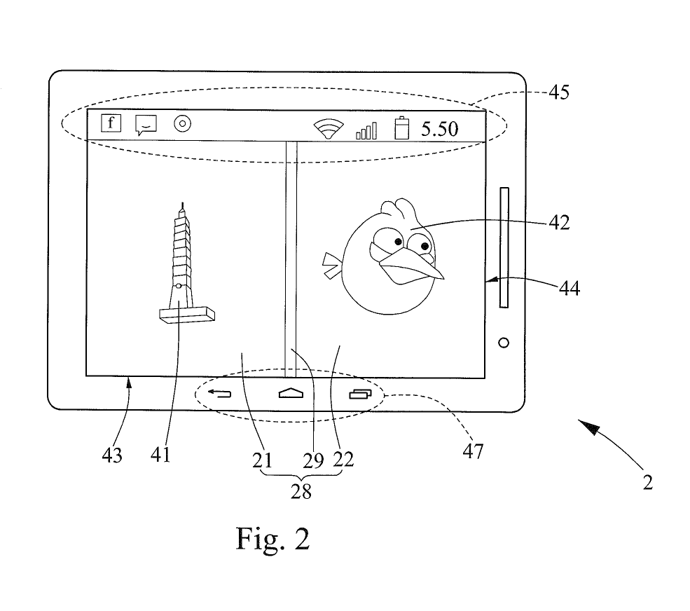

Please refer to FIG. 2 which shows a smart mobile device having a dual-window displaying function according to the second embodiment of the present invention. Similar or same structures and functions are not described. As shown in FIG. 2, when the smart mobile device 2 is disposed to stand on its wider side (in the following will be referred to as “landscape mode”), the first displaying region 21 and the second displaying region 22 are disposed in a left-right layout. In this embodiment, the status bar 45 is disposed above both the first window 43 and the second window 44 and the operation bar 47 is disposed below both the first window 43 and the second window 44. Moreover, the area of the first displaying region 21 is equivalent to the area of the second displaying region. In this case, the first window displaying the first application software 41 fills up the first displaying region 21 along both the horizontal and vertical directions and the second window 44 displaying the second application software 42 also fills up the second displaying region 22 along both the horizontal and vertical directions. That is, the first window couples with the first displaying region 21 and the second window 44 couples with the second displaying region 22. By doing so, the limited area of the screen can be fully used.

Furthermore, a user may rotate the smart mobile device randomly. That is, the smart mobile device may switch between the portrait mode shown in FIG. 1 and the landscape mode shown in FIG. 2 randomly. In general, a gravity sensor (G-sensor) may be installed inside the smart mobile device 2, so the smart mobile device 2 may switch from the portrait mode shown in FIG. 1 to the landscape mode shown in FIG. 2 automatically. Therefore, the embodiment shown in FIG. 1 is a usage status figure of forced portrait mode and the embodiment shown in FIG. 2 is a usage status figure of forced landscape mode.

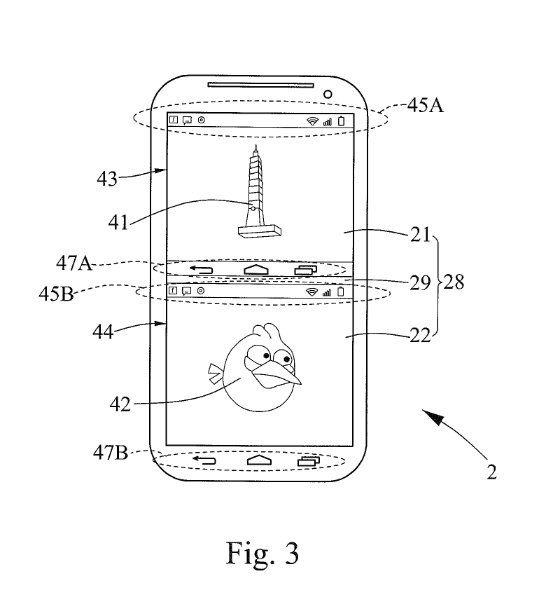

Please refer to FIG. 3 which shows a smart mobile device having a dual-window displaying function according to the third embodiment of the present invention. As shown in FIG. 3, the smart mobile device 2 of this embodiment comprises a first status bar 45A, a second status bar 45B, a first operation bar 47A and a second operation bar 47B. The smart mobile device 2 takes portrait mode and the first window 43 and the second window 44 are disposed in a top-bottom layout. For the first application software 41, the first status bar 45A is disposed above the first window 43 and the first operation bar 47A is disposed below the first window 43. For the second application software 42, the first status bar 45B is disposed above the second window 44 and the second status bar 47B is disposed below the second window 44. That is, the first status bar 45A and the first operation bar 47A are disposed at the periphery of the first window 43 to manipulate and display the first application software 41; the second status bar 45B and the second operation bar 47B are disposed at the periphery of the second window 44 to manipulate and display the second application software 42. The first window 43, the first status bar 45A and the first operation bar 47A are separated from the second window 44, the second status bar 45B and the second operation bar 47B by the separation bar 29. Of course, more functions are shown on the same screen 28, the operation interface is more straightforward on its usage. Moreover, the second status bar 45B of this embodiment is optional, so it may be shown or not shown.

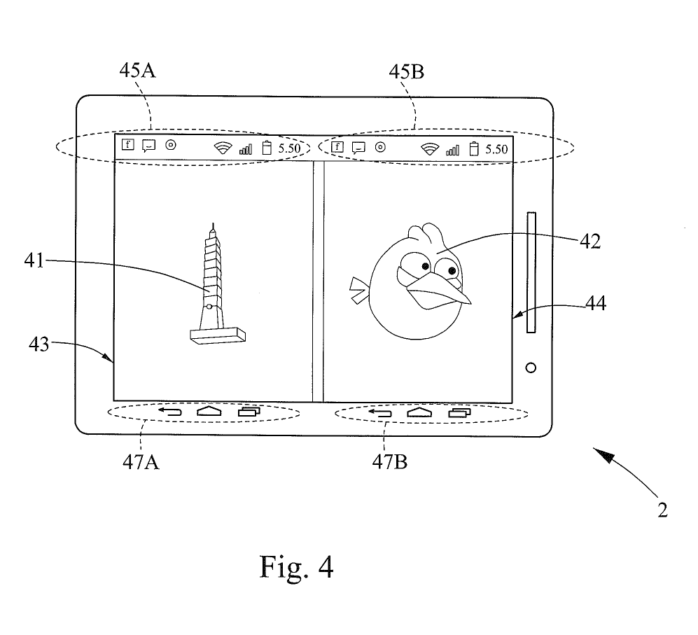

Please refer to FIG. 4 which shows a smart mobile device having a dual-window displaying function according to the fourth embodiment of the present invention. As shown in FIG. 4, when the smart mobile device 2 of this embodiment is disposed in a landscape mode, the first window 43 showing the first application software 41 and the second window 44 showing the second application 42 are disposed in a left-right layout. Furthermore, the first status bar 45A and the first operation bar 47A are disposed above and below the first window 43 respectively; the second status bar 45B and the second operation bar 47B are disposed above the below the second window 44 respectively. Also, the second status bar 45B of this embodiment is optional, so it may be shown or not shown.

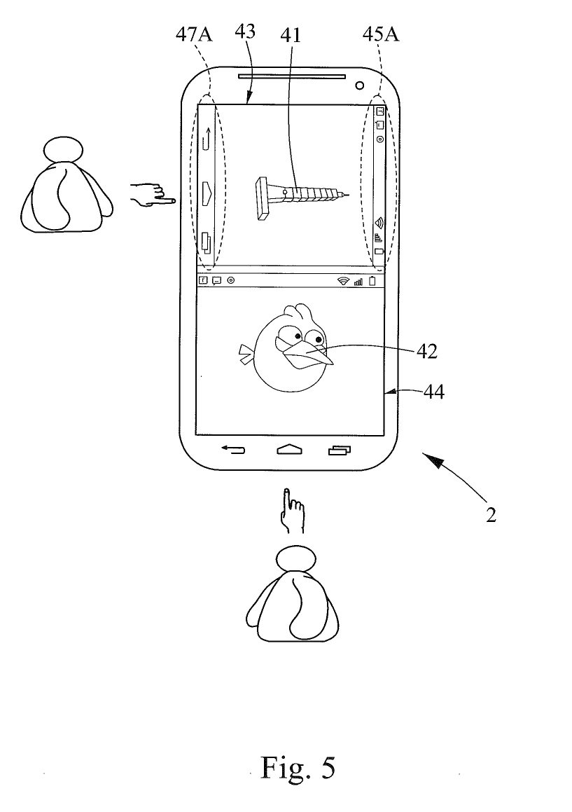

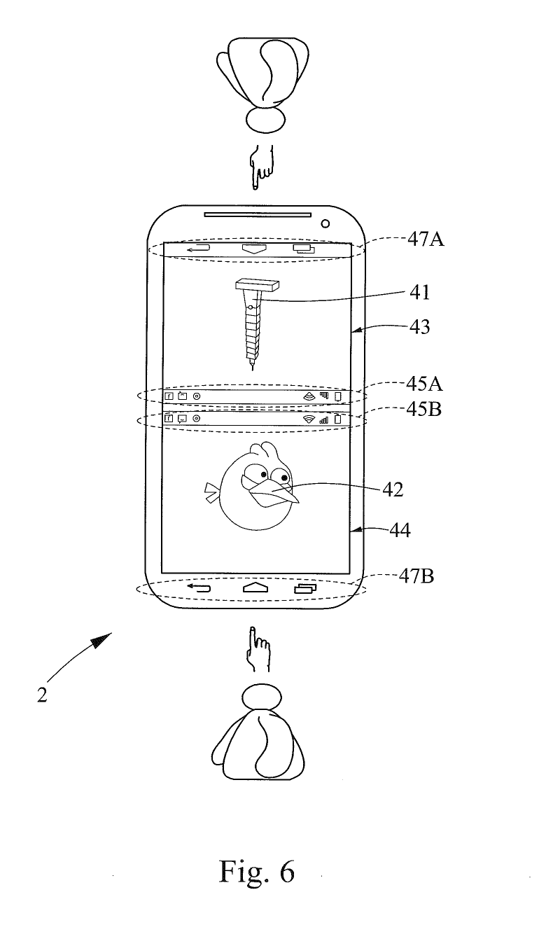

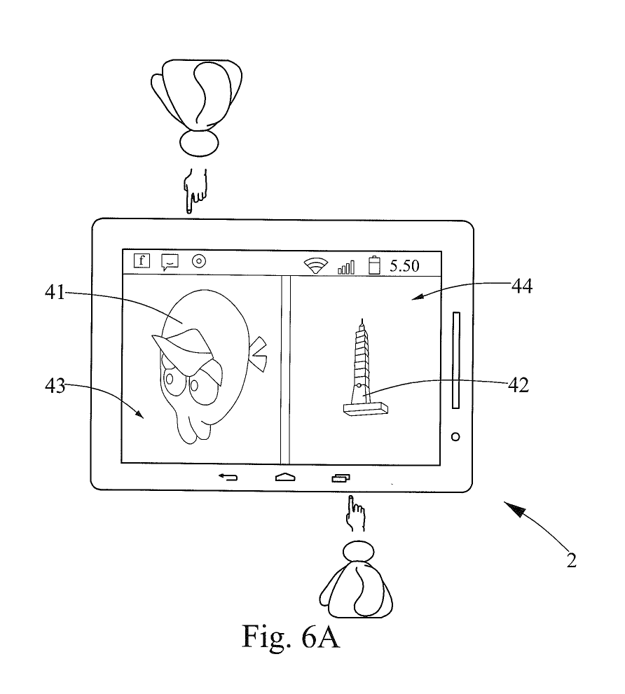

Except various kinds of layouts for windows, status bar and operation bar, the present invention may also change viewing directions of the first application software 41 and the second application software 42 in order to allow two persons to operate and control the smart mobile device from different directions. Please refer to FIGS. 5, 6 and 6A. FIG. 5 shows a smart mobile device having a dual-window displaying function according to the fifth embodiment of the present invention. FIGS. 6 and 6A show a smart mobile device having a dual-window displaying function according to the sixth embodiment of the present invention. As shown in FIG. 5, the viewing directions of the first window 43 and the second window 44 have an included angle of 90 degree. Accordingly, the first status bar 45A and the operation bar 47A share the same viewing direction with the first window 43. As shown in FIGS. 6 and 6A, the viewing directions of the first window 43 and the second window 44 have an included angle of 180 degree. Accordingly, the first status bar 45A and the operation bar 47A are upside down with respect to the second status bar 45B and the operation bar 47B. The difference between the FIG. 6 and FIG. 6A lays in their modes: the smart mobile device 2 shown in FIG. 6 is disposed in a portrait mode while the smart mobile device 2 shown in FIG. 6A is disposed in a landscape mode. Hence, when two persons play a game using the smart mobile device 2, they can control the same smart mobile device 2 by an angle of 90 degree or 180 degree with respect to each other.

Furthermore, the displaying status of the first window 43 in the first displaying region 21 may be adjusted through manual adjustment or system adjustment or software calculating to display different layouts. Of course, the displaying status of the second window 44 in the second displaying region 22 may also be adjusted through manual adjustment or system adjustment or software calculating. The following discussion would use the first window 43 and the first displaying region as examples. However, the second window 44 and the second displaying region 22 would follow the same principles, so their descriptions would be omitted.

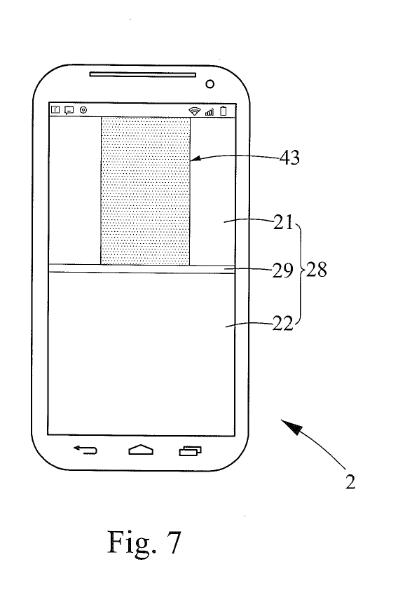

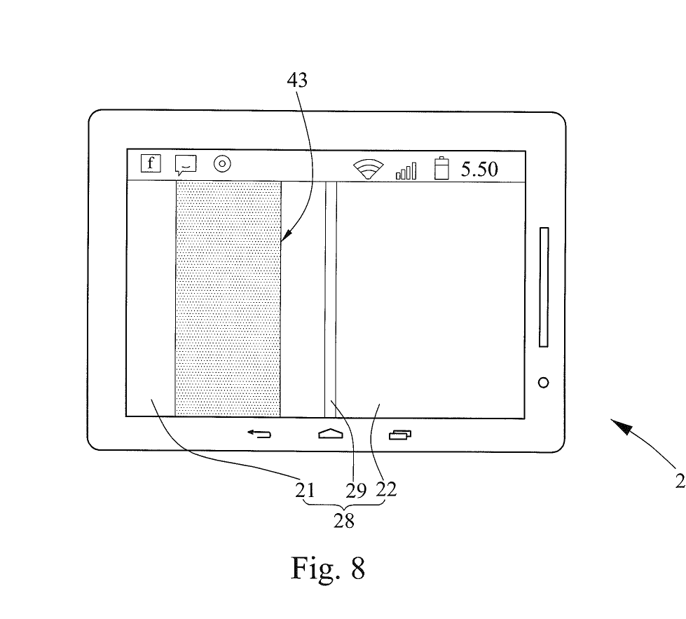

Please refer to FIGS. 7 and 8. FIG. 7 shows a smart mobile device having a dual-window displaying function according to the seventh embodiment of the present invention. FIG. 8 shows a smart mobile device having a dual-window displaying function according to the eighth embodiment of the present invention. As shown in FIG. 7, the smart mobile device 2 is disposed in a portrait mode. The first displaying region 21 is disposed in the upper half of the screen 28. The first window 43 fills up the first displaying region 21 along a vertical direction but does not fill up the first displaying region 21 along a horizontal direction. As shown in FIG. 8, the smart mobile device 2 is disposed in a landscape mode. The first displaying region 21 is disposed in the left half of the screen 28. The first window 43 fills up the first displaying region 21 along a vertical direction but does not necessarily fill up the first displaying region 21 along a horizontal direction.

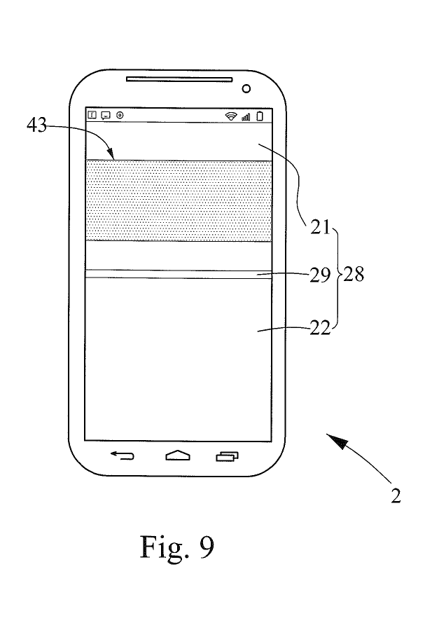

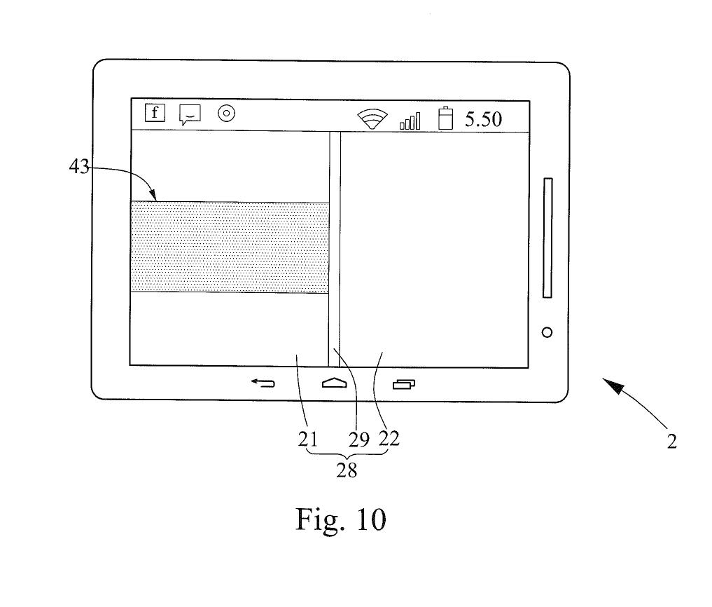

Please refer to FIGS. 9 and 10. FIG. 9 shows a smart mobile device having a dual-window displaying function according to the ninth embodiment of the present invention. FIG. 10 shows a smart mobile device having a dual-window displaying function according to the tenth embodiment of the present invention. As shown in FIG. 9, the smart mobile device 2 is disposed in a portrait mode. The first window 43 fills up the first displaying region 21 along a horizontal direction but does not fill up the first displaying region 21 along a vertical direction. As shown in FIG. 10, the smart mobile device 2 is disposed in a landscape mode. The first window 43 fills up the first displaying region 21 along a horizontal direction but does not necessarily fill up the first displaying region 21 along a vertical direction.

Of course, for some applications, the window may not only fill up the first displaying region 21 along a horizontal direction but also fill up the first displaying region 21 along a vertical direction. More specifically, the displaying of an application occupies the window and the window occupies the entire displaying region or fills up the displaying region along a horizontal or vertical direction or only occupies a portion of the displaying region. This leads to an advantage: no matter which application software is used by the smart mobile device or what default window size should be used by the application software, the smart mobile device 2 of the present invention can adapt for it and adjust the first window 43 and the second window 44 to their optimal status for usage.

By the same principle, the second window 44 may also fill up the second displaying region 22 along a horizontal direction or the second window 44 may also fill up the second displaying region 22 along a vertical direction. The occupying status of the first window 43 and second window 44 occupying the first displaying region 21 and the second displaying region 22 respectively may depend on the application softwares and may be adjusted automatically or manually to allow the smart mobile device 2 of the present invention to deliver the best displaying interface.

As discussed above, the smart mobile device 2 of the present invention may display in different modes mentioned above, so a user may operate and control two windows on the same smart mobile device 2 fluently. More detailed descriptions are provided below to introduce a method for using and controlling the smart mobile device 2:

“single-user dual-window” mode:

As shown in FIGS. 1 and 3, the smart mobile device may be operated in a portrait mode. As shown in FIGS. 2 and 4, the smart mobile device may be operated in a landscape mode. In the portrait mode, the two windows of the smart mobile device 2 are disposed in a top-bottom layout. In the landscape mode, the two windows of the smart mobile device 2 are disposed in a left-right layout. Moreover, a user may switch between the portrait mode and the landscape mode automatically through rotating the smart mobile device. In the following descriptions, the system management for “single-user dual-window” mode will be discussed in detail:

1) System Bar Management

The smart mobile device 2 may have different operational management modes through the “system bar management” to allow a user to manage two windows and two application softwares. As shown in the smart mobile devices 2 shown in FIGS. 1 and 2, a user may use a status bar 45 and a operation bar 47 to operate and control the first application software 41 shown in the first window 43 and the second application software 42 shown in the second window 44, so the user may see the system status of these two application softwares through only the status bar 45 and operate various functions of these two application softwares through the operation bar 47. More specifically, when the user uses this mode, he or she may use the status bar 45 to display and monitor system's environmental settings for the entire smart mobile device and display the status of these two application softwares. There may be various ways of executing the operation bar to make the operation bar designate the window to be controlled. For example, the window designated by the operation bar may be the window getting input focus. To prompt the window designated by the operation bar, different prompting methods may be used to prompt the user. By doing so, the user can clearly know which operation bar is configured to control which window.

In other displaying modes as shown in FIGS. 3-6, the smart mobile device 2 may further use two status bars and two operation bars to control the first application software 41 and the second application software 42. In other embodiments, “one status bar and two operation bars” or “two status bars and one operation bar” may also be adopted to operate and control the system or application softwares running in the smart mobile device.

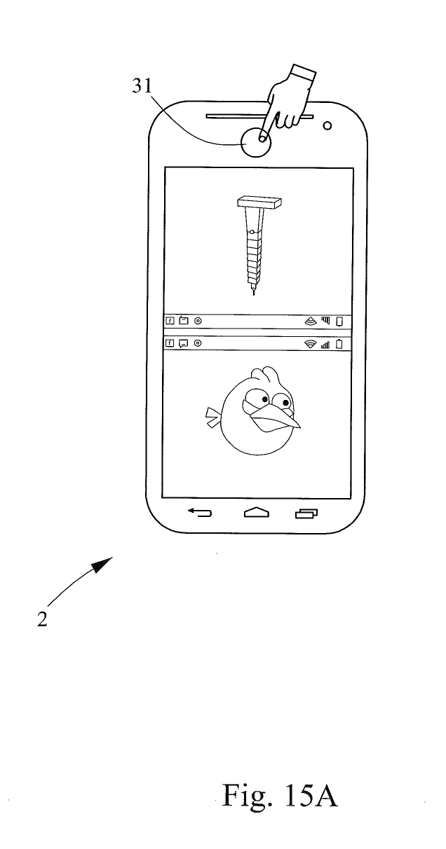

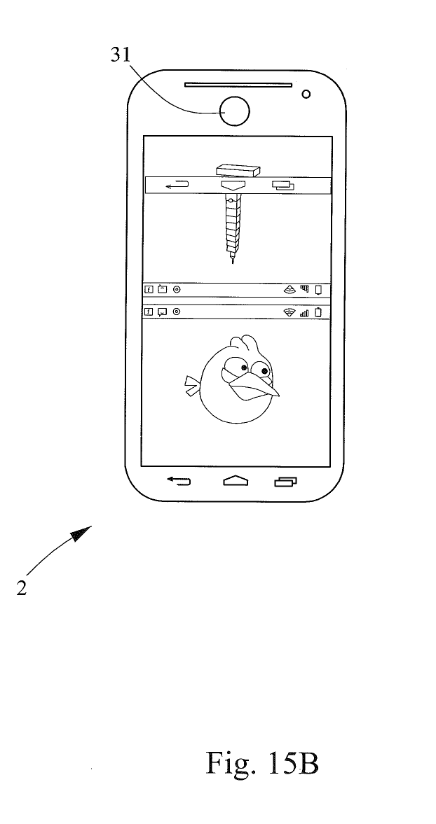

Sometimes the status/operation bar may not be visible all the time; instead use can trigger its appearance by pushing or triggering a functional key 31 (as shown in FIGS. 15A and 15B) and the functional key can be a hard key or even a soft key.

Separation Bar Management

The purpose of the separation bar is to split the first displaying region from the second displaying region. The present invention allows a user to drag the separation bar 29 to change the layout arrangement of the screen (that is to change the area sizes of the first displaying region and the second displaying region) or to touch the separation bar 29 for a while to trigger system commands (such as “swap application softwares between two windows”, “move one application software from one window to the other”, “exit dual-window mode”, “rotate window and switch to dual-user dual-window mode”, “mute the audio of one window”), the user could have a better experience on using the smart mobile device.

Application Rendering Management

When two application softwares are shown on the same screen 28, there may be various layouts to show the first window 43 and the second window 44. When the operating system switches between the full screen mode and the “dual-window mode” or between the portrait mode and the landscape mode or changes the sizes of the displaying regions by dragging the separation bar, the displaying sizes of the windows may change accordingly. That is, the first application software 41 or the second application software 42 can calculate the sizes of the displaying windows, considerate the displaying configurations available to the displaying windows and change its displaying content dynamically.

Under the full screen mode, a user may choose the portrait mode or the landscape mode to use the smart mobile device randomly. By this, even though an application software only supports the portrait mode or the landscape more, the user may still use the method disclosed therein to operate the application software without any problems.

If application softwares are classified based on their displaying behaviors, they can be classified into “auto-fit” type and “force-layout” type. The application software of the auto-fit type would change its displaying content along with the change of window size (including change of size due to rotation) and based on the real window size. The application software of the force-layout type would not change its displaying content dynamically to fit the changes of window size and orientation.

Process for Application Softwares of Force-Layout Type

In the controlling method of the present invention, for this type of application software, the system would create a full screen image for this application software as if the device is in its full screen mode. Then, the system would scale the full screen image so it would fit into the window and be put into the displaying region. Herein, the way of scaling the image could be direct zooming the image to keep the width/height ratio or scaling and stretching the image to fully fit a corresponding window size in the dual-window mode. It should be noted that scaling and stretching mode could render width or height stretching distortion due to different width and height stretching ratios. This mode would affect viewing experience adversely, so it is not recommended.

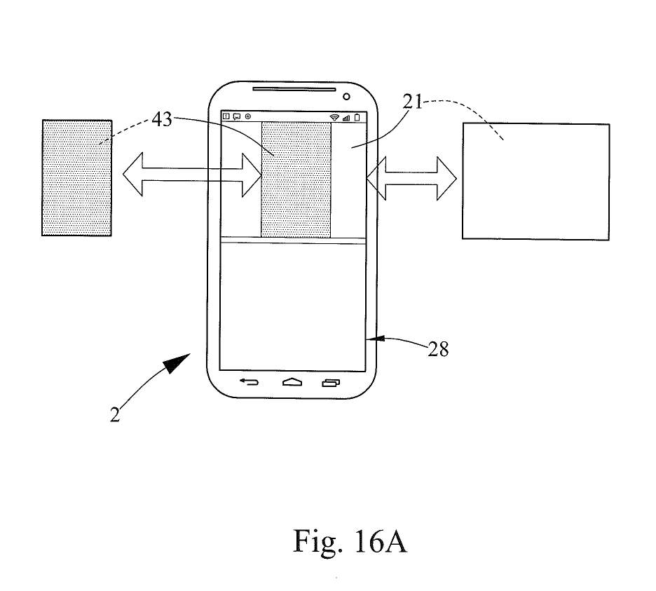

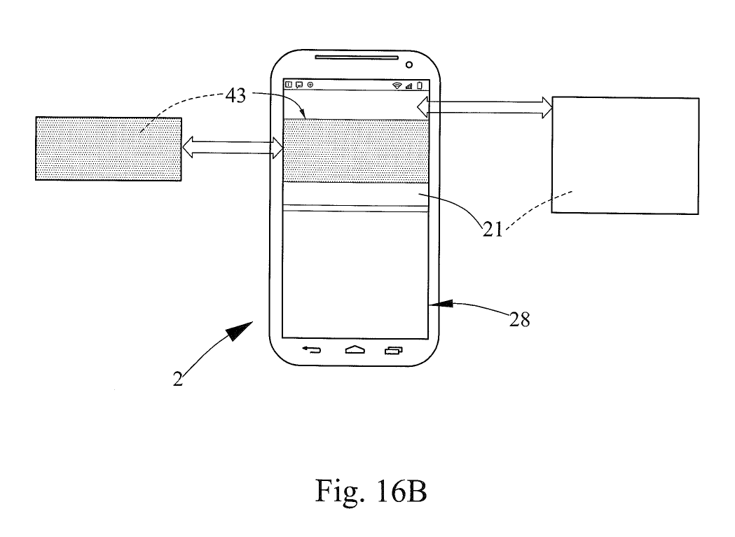

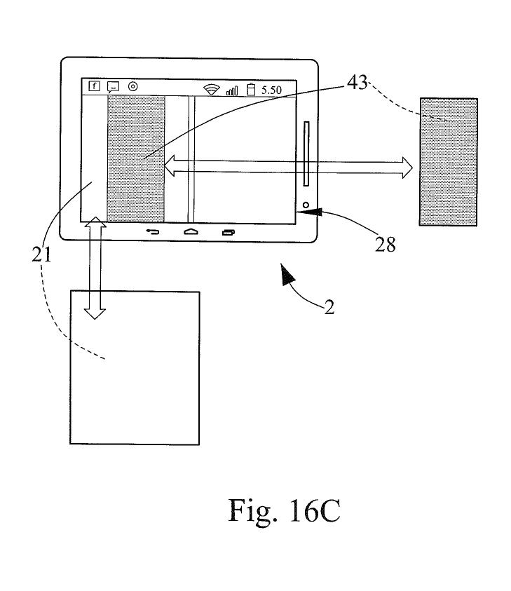

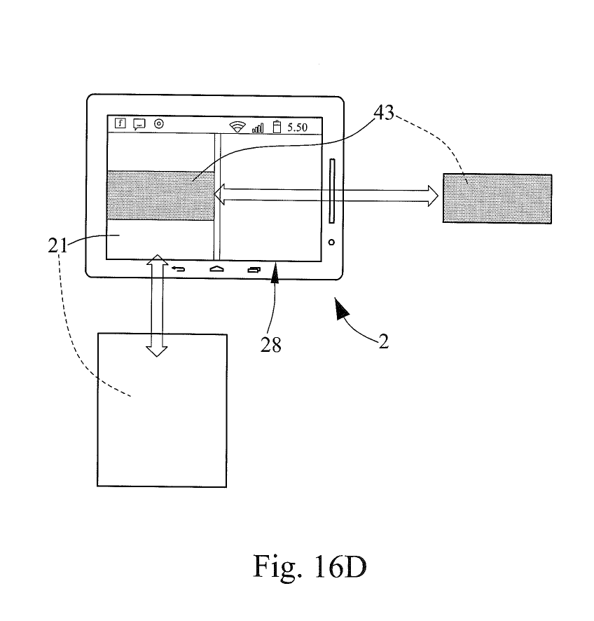

In a dual-window mode, the first window 43 under force-layout mode would not fill up the first displaying region 21. FIGS. 16A-16D show different displaying modes for a force-layout application software under different rotational statuses. As shown in FIG. 16A, while the smart mobile device 2 is in a portrait mode and the screen 28 is in dual-window mode, by the method of the present invention, the system can report the original portrait mode full window and the available displaying region in a dual-window mode to the application software so the application software can render the first window 43 (under portrait mode) put in the first displaying region 21 of the upper portion of the screen 28 in a fixed width/height ratio. Similarly, as shown in FIG. 16B, while the smart mobile device 2 is in a portrait mode and the screen 28 is in dual-window mode, by the method of the present invention, system can report the original landscape mode full window and the available window in dual-window mode to the application software so the application software can render the first window 43 (under landscape mode) put in the first displaying region 21 of the upper portion of the screen 28 in a fixed width/height ratio.

As shown in FIG. 16C, while the smart mobile device 2 is in a landscape mode and the screen 28 is in dual-window mode, by the method of the present invention, system can report the original landscape mode full window and the available window in dual-window mode to the application software so the application software can render the first window 43 (under portrait mode) put in the first displaying region 21 of the left portion of the screen 28 in a fixed width/height ratio.

As shown in FIG. 16D, while the smart mobile device 2 is in a landscape mode and the screen 28 is in dual-window mode, by the method of the present invention, system can report the original landscape mode full window and the available window in dual-window mode to the application software so the application software can render the first window 43 (under landscape mode) put in the first displaying region 21 of the left portion of the screen 28 in a fixed width/height ratio.

Process for Application Softwares of Auto-Fit Type

For application softwares supporting auto-fit function, the image displaying region of the application software would completely couple with the available displaying region 21.

For displaying regions that are too small, even though the application softwares support auto-fit function, these application softwares can not be displayed correctly. In this situation, the system would provide a window whose width/height ratio is the same as the displaying region for the application software to render. After finishing rendering, the image rendered would be put into the displaying region in the same width/height ratio.

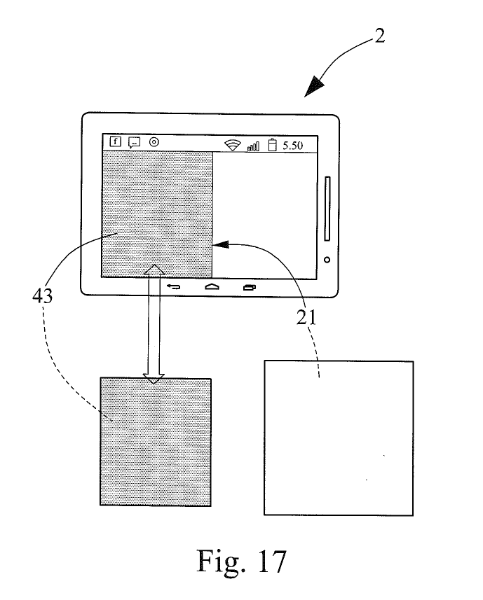

In this way, as shown in FIG. 17, the height of the first rendering window would be equivalent to the height of the first displaying region 21 multiplying a scaling ratio and the width of the first rendering window would be equivalent to the width of the first displaying region 21 multiplying the scaling ratio. In general, because different devices have different sizes or the first displaying region is too small, the default scaling ratio would not be 1.0. Therefore, it is preferably for an operating system to define a threshold value and scale the rendering window according to a scaling ratio corresponding to the threshold value. However, there are many ways to calculate or choose the scaling ratio and the present invention is not limited to a specific one.

Of course, even for the application softwares supporting the “auto-fit” function, it is also possible to keep the width/height ratio as if under full screen mode. In this case, the management would be similar to the one for “force-layout” function. The detailed steps and method for scaling a window are shown in FIG. 13 and their detailed descriptions are provided below:

After launching an application software, perform step X1 of determining whether the application software supports the auto-fit function. If the application software supports the auto-fit function, then perform step X2 of determining whether the application software would fill up the entire available window. If the answer for X2 is “Yes”, then perform step X3 of determining the scaling ratio. Next, perform step X4 of having the application render based on a new window, wherein the new window is decided by the available window sizes of the displaying region 21 and 22 multiplying a scaling ratio. If the answer for X2 is “No”, then perform step X8 of determining whether the displaying region is in a portrait mode. If the answer for X8 is “No”, then perform step X5 of determining whether the application software is force-portrait type. If the answer for X5 is “Yes”, then perform step X6 of having the application software render based on a new window, wherein the new window is decided by the original portrait mode window in full screen mode of the smart mobile device 2. If the answer for X5 is “No”, then perform step X7 of having the application software render based on a new window, wherein the new window is decided by the original landscape mode window in full screen mode of the smart mobile device 2. Finally, after performing step X4, X6 or X7, perform step X9 of having the application software render image/content. Next, perform step X10 of having the system scale the rendered image/content so the rendered image/content would fit into the new window and be disposed in the correct location.

By doing so, the smart mobile device 2 of the present invention can render the first window 43 or the second window 44 auto fit into the first displaying region 21 and the second displaying region through the application rendering management.

Window Layout Management

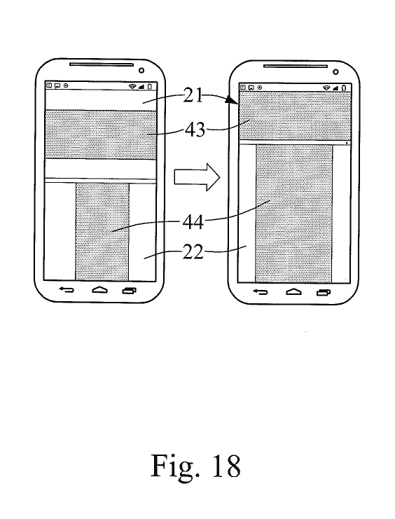

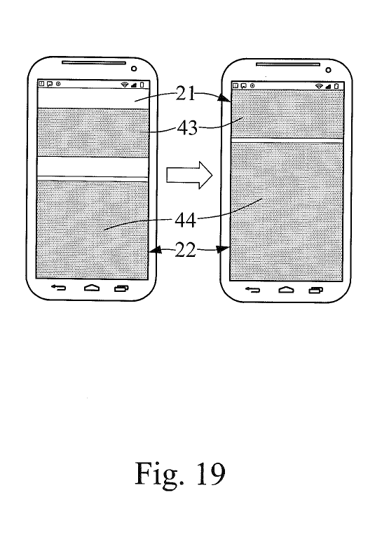

In the default setting of the dual-window mode, each displaying region would be set to have the same size. Under this default setting, if one window can not completely occupy one displaying region, then there would be a blank space left. In many cases, it is possible to change the size of the displaying region so as to minimize the blank space, so the existed screen space is well used to render the best displaying effect. As shown in FIGS. 18 and 19, when the smart mobile device 2 is in a portrait mode, by making one of the application softwares a force-landscape mode (first window 43) and making the other of the application softwares a force-portrait mode or auto-fit mode (second window 44), it is possible to assure the displaying of the first window 43 by adjusting the size of the displaying region, then leave the remained space to the second application software to render. Specifically, it goes as the following: adjusting the height of the first window 43 so the first window 43 would fit the first displaying region 21 completely; moving the separation bar 29 so the separation bar 29 would be closer to the first window 43; and expanding the second displaying region 22 so the second window 44 can be displayed better.

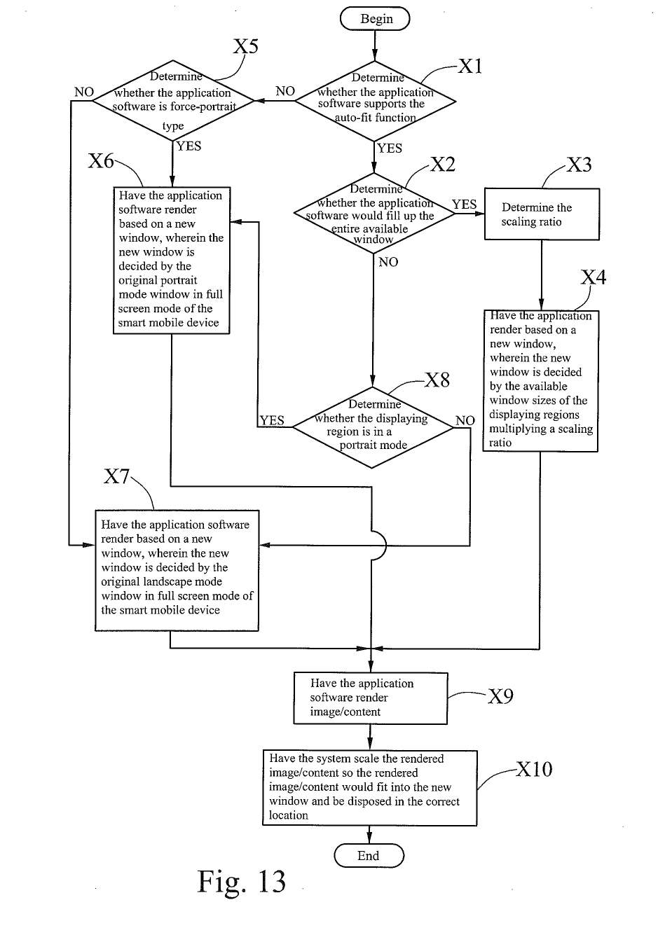

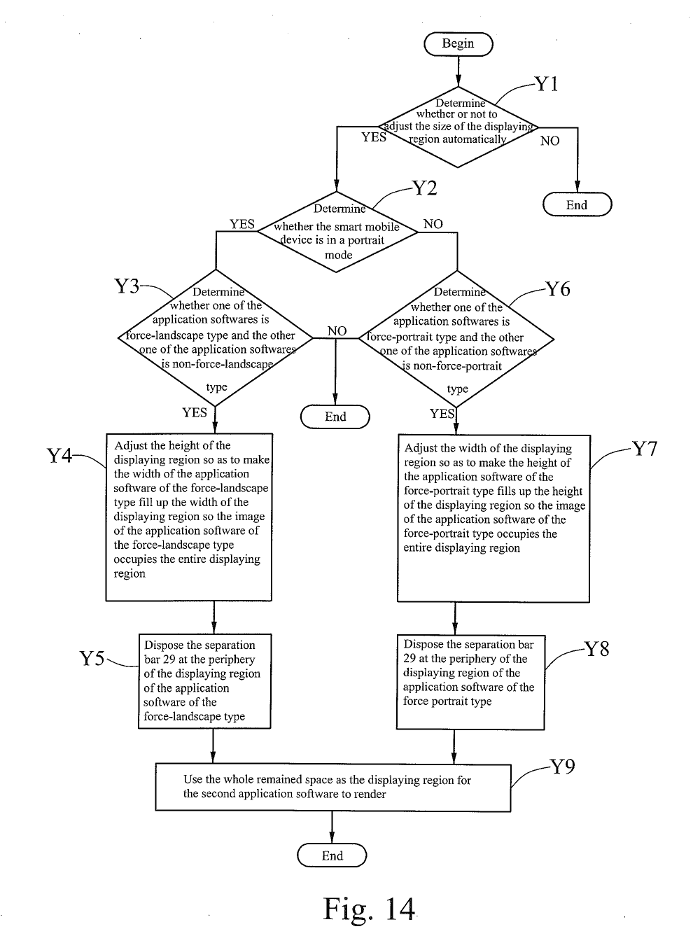

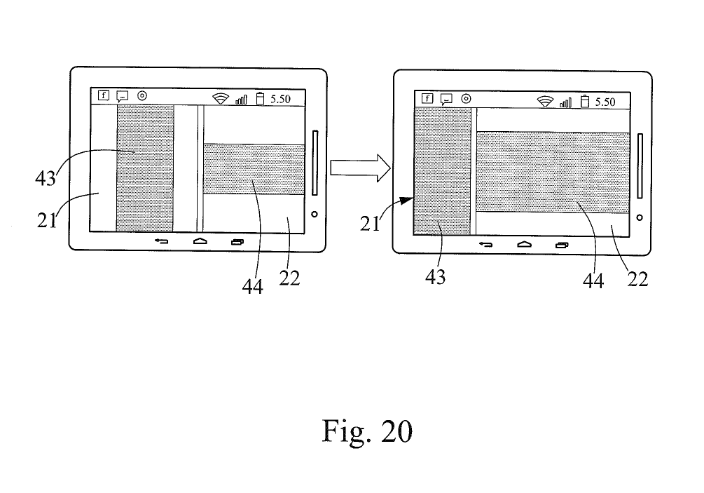

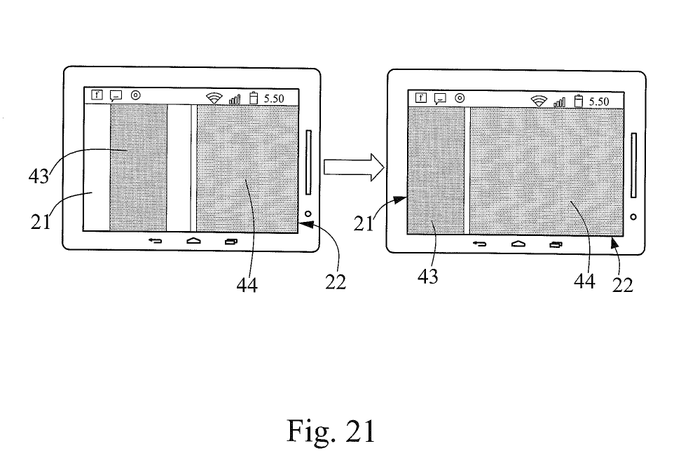

As shown in FIGS. 20 and 21, when the smart mobile device is in the landscape mode and one of the application softwares is in the force-portrait mode (the first window 43) while the other of the application softwares is in the force-landscape mode or auto-fit mode (the second window 44), it is possible to assure the displaying of the first window 43 by adjusting the size of the displaying region, then leave the remained space to the second application software to render. Specifically, it goes as the following: adjusting the width of the first window 43 so the first window 43 would fit the first displaying region 21 completely; moving the separation bar 29 so the separation bar 29 would be closer to the first window 43; and expanding the second displaying region 22 so the second window 44 can be displayed better. Herein the determining algorithm is shown in the FIG. 14 and the detailed explanation is provided below:

Perform step Y1 of determining whether or not to adjust the size of the displaying region automatically. If the answer for Y1 is “No”, then end adjusting of the displaying region. If the answer for Y1 is “Yes”, then perform step Y2 of determining whether the smart mobile device is in a portrait mode. If the answer for Y2 is “Yes”, then perform step Y3 of determining whether one of the application softwares is force-landscape type and the other one of the application softwares is non-force-landscape type. If the answer for Y3 is “No”, then end adjusting of the displaying region. If the answer for Y3 is “Yes”, then perform step Y4 of adjusting the height of the displaying region so as to make the width of the application software of the force-landscape type fill up the width of the displaying region so the image of the application software of the force-landscape type occupies the entire displaying region. After completing Y4, perform Y5 of disposing the separation bar 29 at the periphery of the displaying region of the application software of the force-landscape type. If the answer for Y2 is “No”, then perform step Y6 of determining whether one of the application softwares is force-portrait type and the other one of the application softwares is non-force-portrait type. If the answer for Y6 is “No”, then end adjusting of the displaying region. If the answer for Y6 is “Yes”, then perform step Y7 of adjusting the width of the displaying region so as to make the height of the application software of the force-portrait type fill up the height of the displaying region so the image of the application software of the force-portrait type occupies the entire displaying region. After completing step Y7, perform step Y8 of disposing the separation bar 29 at the periphery of the displaying region of the application software of the force portrait type. Finally, after completing step Y5 or Y8, perform step Y9 of using the whole remained space as the displaying region for the second application software to render.

Hence, the smart mobile device 2 of the present invention can optimize the displaying of the first window 43 and the second window 44 through window layout management, so not much blank region is created to waste the usage space of the screen 28.

5) Touch Event Management

Generally, the size of each window in the dual-window mode is different from the original window size the application software is rendering. Therefore, two windows need calculations to couple with the screen 28 of the smart mobile device 2. Usually it is done by capturing the (X, Y) axis position in the dual window, normalizing it to get normalized (X, Y) axis position, mapping the normalized (X, Y) axis position to the new (X, Y) axis position in the new window and sending the new (X, Y) axis position to the operating system for execution.

6) Enter and Exit Dual Window Mode

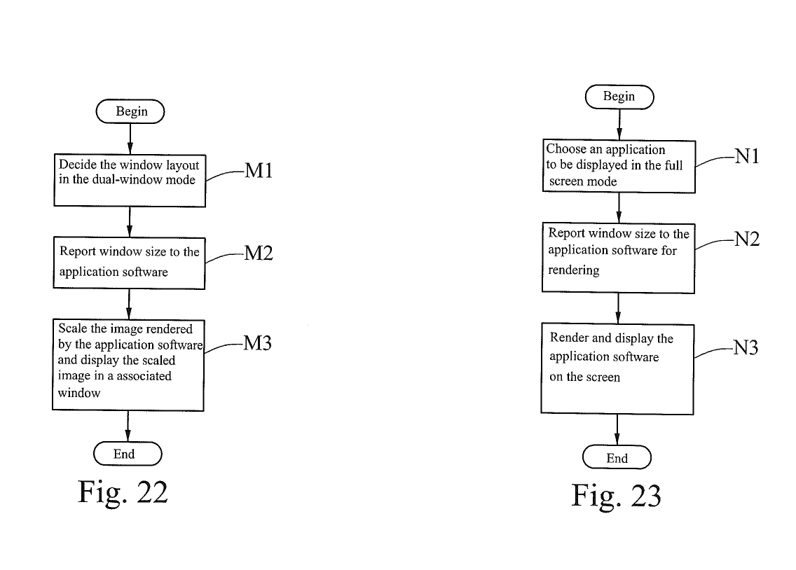

As shown in FIG. 22, the smart mobile device 2 of the present invention follows the steps described below to enter dual-window mode. First, perform step M1 of deciding the window layout in the dual-window mode. Next, perform step M2 of reporting window size to the application software. Finally, perform step M3 of scaling the image rendered by the application software and displaying the scaled image in a associated window.

As shown in FIG. 23, the smart mobile device 2 of the present invention follows the steps described below to exit dual-window mode and go back to full screen mode. First, perform step N1 of choosing an application software to be displayed in the full screen mode. Next, perform step N2 of reporting window size to the application software for rendering. Finally, perform step N3 of rendering and displaying the application software on the screen.

Dual-User Dual-Window Mode:

As shown in FIGS. 5, 6 and 6A, the smart mobile device may be used by two users at the same time. In the smart mobile device shown in FIG. 5, the screen is in a portrait mode, the first window 43 and the second window 44 are disposed in a top-bottom layout and the viewing directions of the two users have an included angle of 90 degree. In the smart mobile device shown in FIG. 6, the screen is in a portrait mode, the first window 43 and the second window 44 are disposed in a top-bottom layout and the viewing directions of the two users have an included angle of 180 degree. In the smart mobile device shown in FIG. 6A, the screen is in a landscape mode, the first window 43 and the second window 44 are disposed in left-right layout and the viewing directions of the two users also have an included angle of 180 degree.

Furthermore, in the dual-user dual-window mode, except the interaction method to be discussed below, most of the executing method and steps are similar to the ones of the single-user dual-window mode. More detailed descriptions are provided below to discuss the system management of the dual-user dual window mode:

1) System Bar Management

As described above, two users may view the application softwares shown on their own windows from their own viewing directions respectively. Therefore, it is necessarily to have two operation bars. The status bar can still be one if it combines both application softwares statues.

2) Window Layout Management

As shown in FIG. 6, the difference on the window layout managements for single-user dual-window mode and dual-user dual-window mode lies on the viewing direction. The other user has to view and operate his or her application software from an opposite direction (the viewing directions of two users have an included angle of 180 degree or 90 degree). Hence, the status bar and the operation bar of the other user have to be opposite to their counterparts.

3) User Interaction Method

As discussed above, since one window is rotated 180 degree or 90 degree to be opposite the other window, its touch event should map to its touch location accordingly.

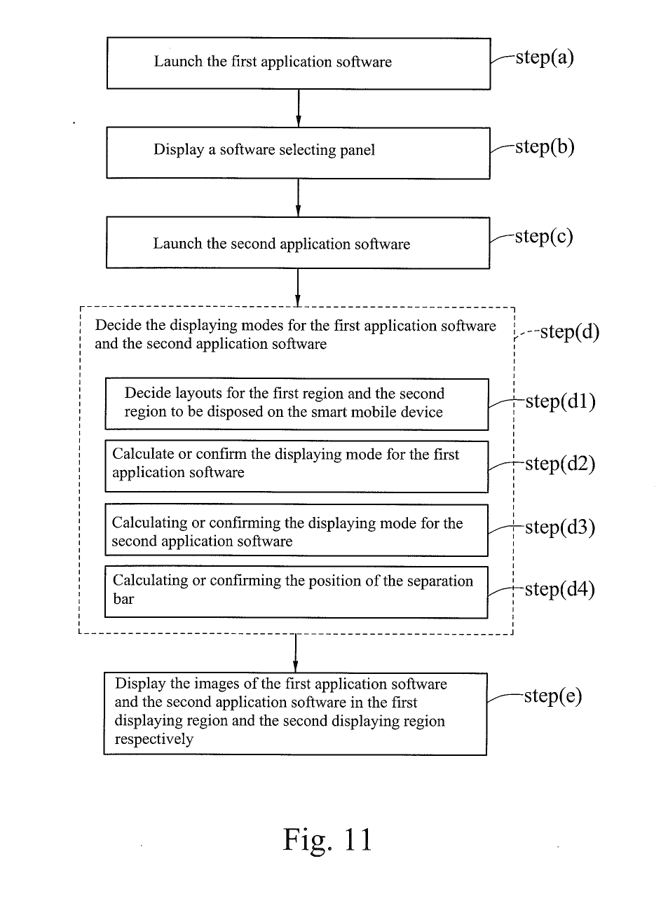

Furthermore, in order to render the smart mobile device 2 in “single-user dual-window mode” or “dual-user dual-window mode”, the present invention further provides a method for controlling the smart mobile device 2 having a dual-window function. Please refer to FIG. 11. FIG. 11 is a flow chart showing the method for controlling the smart mobile device having a dual-window function. As shown in FIG. 11, the method for controlling the smart mobile device 2 according to the present invention divides the screen 28 of the smart mobile device 2 into a first displaying region 21 and a second displaying region 22 configured to display and control a first application software and a second application software respectively, so the dual-window function can be achieved. The controlling method comprises the following steps: step a) of launching the first application software; step b) of displaying a software selecting panel; step c) of launching the second application software; step d) of deciding the displaying modes for the first application software and the second application software; step e) of displaying the images of the first application software 41 and the second application software 42 in the first displaying region 21 and the second displaying region respectively.

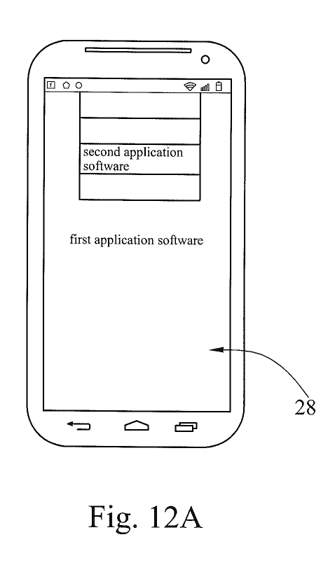

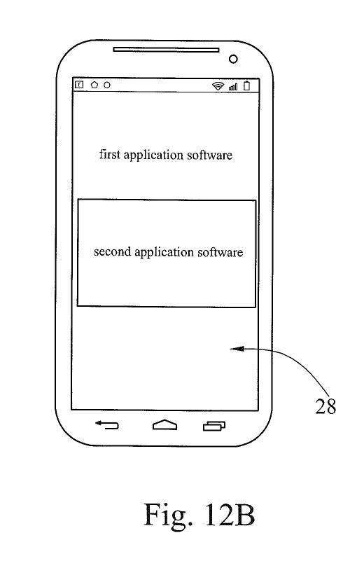

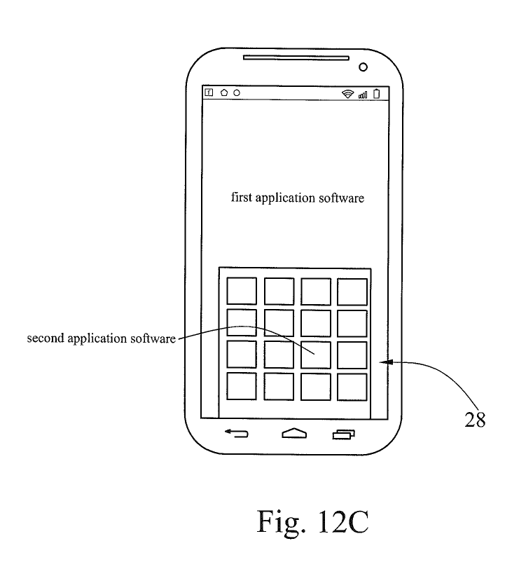

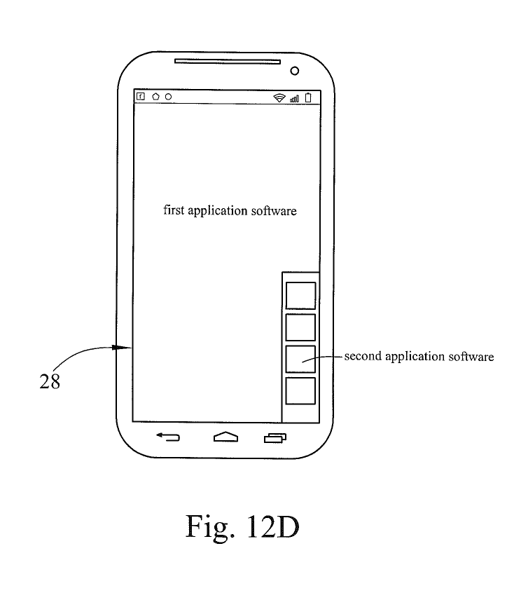

There are different ways entering the dual-window mode from the full-screen mode. Please refer to FIGS. 12A-12D. In FIG. 12A, the pull down status bar of the system can be a launching portal for launching the second application software. In a simple full-screen mode, a user may click or touch one item in the status bar to launch a corresponding application software. Here, we can make the system enter the dual-window mode, the previous application software and the new application software launched by clicking or touching the status bar may be displayed on two windows. In FIG. 12B, system pops up a dialogue box. In a simple full-screen mode, a user may launch an application software such as text message application software through a dialogue box. Here, we can make the system enter the dual-window mode. The previous application software and the new application software launched by clicking or touching the dialogue box may be displayed on two windows. In FIG. 12C, a user launches a mini launcher panel by a certain way. The “mini launcher panel” allows a user to choose an additional application software to be launched and this additional application software would be shown together with the previous application software in the dual-window mode. Furthermore, after a user used many application softwares, it is possible to choose the application software to be used from a history panel of the previously-used application softwares. Next, please refer to FIG. 12D. The history panel of the previously-used application softwares allows a user to pick an application software to be used from a list of previously-used application softwares. That is, while a user is using the first application software 41, he or she can quickly pick the second application software 42 to be used from the history panel of previously-used application softwares on the right bottom corner. Now system enters dual-window mode and two application softwares can be shown on the screen at the same time. Simply put, the smart mobile device of the present invention allows users to launch two application softwares one after another and to display these two application softwares on dual-window mode (portrait mode or landscape mode) in the same screen 28.

Then, after performing step c) of launching the second application software, the window layout for the dual-window mode can be decided. The window layout includes but not limited to all the window layouts shown in FIGS. 1-10.

When performing step d) of deciding displaying modes for the first application software 41 and the second application software 42 in FIG. 11, the operating system of the smart mobile device actually performs the following steps: step d1) of deciding layouts for the first region 21 and the second region 22 to be disposed on the smart mobile device 2 and confirming a position of a separation bar 29, the separation bar 29 is disposed between the first region 21 and the second region 22; step d2) of calculating or confirming the displaying mode for the first application software 41; step d3) of calculating or confirming the displaying mode for the second application software 42; step d4) of calculating or confirming the position of the separation bar 29.

Specifically, the detailed flow of step d) of deciding displaying modes for the first application software 41 and the second application software 42 may be for example the flow shown in FIG. 13.

Finally, when performing e) of displaying the images of the first application software 41 and the second application software 42 in the first displaying region 21 and the second displaying region respectively, the detailed flow of step e) may be for example the flow shown in FIG. 14.

To sum up, the smart mobile device 2 having a dual-window displaying function of the present invention allows a user to operate and control two application softwares on a display screen 28 of the smart mobile device 2 and allows these two application softwares to transfer files and data created therefrom and communicate with each other. Furthermore, the present invention discussed various better ways to display application softwares in two displaying regions and how application softwares interact in the dual-window mode. Two displaying regions are capable of arranging application softwares in the screen in a more efficient way. Moreover, the method for controlling a smart mobile device having a dual-window displaying function according to the present invention allows a user to control and switch displayed images showing these two application softwares fluently and conveniently either by default setting or manually.

The embodiments described above are rather illustrative for explaining the technical features of the present invention than limiting for defining the scope of the present invention. Any changes or modifications without departing from the spirit or scope of the present invention are alternatives or equivalents to the embodiments of the present invention and should fall within the scope of the present invention which is defined by the appended claims.

What is claimed is:

1. A smart mobile device having a dual-window displaying function comprising:
a first displaying region configured to display a first application software, the first application software is shown in a first window;
a second displaying region configured to display a second application software, the second application software is shown in a second window;
at least one status bar configured to optionally display a system status of the first application software or the second application software and disposed at a periphery of the first window or the second window;
at least one operation bar configured to control the first application software or the second application software and being optionally hidden or displayed at the periphery of the first window or the second window; and
a separation bar disposed between the first displaying region and the second displaying region in a mobile way,
wherein the first displaying region and the second displaying region are arranged in a top-bottom layout or a left-right layout.

2. The smart mobile device having a dual-window displaying function of claim 1, wherein the operation bar is disposed above the first window or the second window.

3. The smart mobile device having a dual-window displaying function of claim 2 further comprising a first operation bar and a second operation bar, wherein the first operation bar is disposed above the first window while the second operation bar is disposed above the second window.

4. The smart mobile device having a dual-window displaying function of claim 1, wherein the operation bar is disposed below the first window or the second window

5. The smart mobile device having a dual-window displaying function of claim 4 comprising a first operation bar and a second operation bar, wherein the first operation bar is disposed below the first window while the second operation bar is disposed below the second window.

6. The smart mobile device having a dual-window displaying function of claim 1, wherein viewing directions of the first window and the second window have an included angle of 90 or 180 degree therebetween.

7. The smart mobile device having a dual-window displaying function of claim 1, wherein the first window fills up the first displaying region along a horizontal direction or along a vertical direction or along both horizontal and vertical directions.

8. The smart mobile device having a dual-window displaying function of claim 1, wherein the second window fills up the second displaying region along a horizontal direction or along a vertical direction or along both horizontal and vertical directions.

9. A method for controlling a smart mobile device having a dual-window displaying function, configured to split the smart mobile device into a first displaying region and a second displaying region and to control a first application software and a second application software in order to achieve the dual-window displaying function, this method comprising:
a) launching the first application software;
b) displaying a software selecting panel;
c) launching the second application software;
d) deciding displaying modes of the first application software and the second application software; and
e) displaying images of the first application software and the second application software in the first displaying region and the second displaying region respectively.

10. The method for controlling a smart mobile device having a dual-window displaying function of claim 9, wherein the software selecting of step b) may be achieved through a pull-down status bar, a pop-up dialogue box, a program initiating panel or a history panel of previously opened application softwares.

11. The method for controlling a smart mobile device having a dual-window displaying function of claim 9, wherein the step d) of deciding displaying modes of the first application software and the second application software further comprises the following steps:
d1) deciding layouts for the first region and the second region to be disposed on the smart mobile device and confirming a position of a separation bar;
d2) calculating or confirming the displaying mode for the first application software; and
d3) calculating or confirming the displaying mode for the second application software.
